(19) United States
(12) Patent Application Publication
(10) Pub. No.: US 2013/0231989 A1
(43) Pub. Date: Sep. 5, 2013

(54) VIDEO REVIEWS FOR CONSUMER PRODUCTS

(71) Applicant: Fathi H. Abu Ayyash, Greenville, NC (US)

(72) Inventor: Fathi H. Abu Ayyash, Greenville, NC (US)

(21) Appl. No.: 13/411,498

(22) Filed: Mar. 2, 2012

(51) Int. Cl. G06Q 30/02; G06Q 30/06

(52) U.S. Cl. 705/14.19; 705/26.61

(57) ABSTRACT

A system and method allows users to post reviews as video clips, showing others what their experience was and if the product was useful or not. Such video reviews add credibility to the reviewer. The video review may also allow the user to rate the product based on various individual factors, such as price, quality and functionality. Unlike conventional review systems, where an average review may be provided for the product, the review system and method of the present invention allows a user to rate individual factors, providing the consumer with improved information from the review. The system and method may be provided as an internet web site, where users may register, post and search for reviews of various products.

### BACKGROUND OF THE INVENTION

The present invention relates to product review methods and, more particularly, to video reviews for consumer products posted by individuals and professionals where the video reviews are eligible for profit sharing, rewards, prize drawings and the like.

Written reviews often don't have credibility since the author is unknown. Conventional review websites usually use star ratings, such as one to five stars.

These sites, however, miss the actual rating based on the average rating of various factors, such as price, quality, functionality, and the like.

As can be seen, there is an improved need for a system and method for providing product reviews.

### SUMMARY OF THE INVENTION

In one aspect of the present invention, a computer-implemented method, written as a programmable code, stored on a computer readable medium, and adapted to provide a product review website, the method comprises accepting a video review about a product from a user; accepting a product rating for the product, the product rating including a plurality of product factors, each of the plurality of product factors receiving their own individual review score; permitting users to search and see the product reviews; and permitting users to comment on product reviews.

These and other features, aspects and advantages of the present invention will become better understood with reference to the following drawings, description and claims.

### BRIEF DESCRIPTION OF THE DRAWINGS

FIG. 1 is a flow chart describing a method according to an exemplary embodiment of the present invention;

FIG. 2 is a continuation of the flow chart of FIG. 1; and

FIG. 3 is a continuation of the flow chart of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method that allows users to post reviews as video clips, showing others what their experience was and if the product was useful or not. Such video reviews add credibility to the reviewer. The video review may also allow the user to rate the product based on various individual factors, such as price, quality and functionality. Unlike conventional review systems, where an average review may be provided for the product, the review system and method of the present invention allows a user to rate individual factors, providing the consumer with improved information from the review. The system and method may be provided as an internet web site, where users may register, post and search for reviews of various products.

The system and methods of the present invention, as described herein, may function as a public website that allows users to browse and search any product review based on key words, barcode, item number, model number, description, and the like. In some embodiments, users will be required to register as a member in order to post a review for new products or any existing one. Each post can be scanned for approval, for example, for the use of offensive language, any sexual materials, nudity, alcohol or tobacco use, and the like. Such approval scanning can be used to qualify the video post. In some embodiments, the reviewer is required to rate the product in various factors as defined by the product category. For example, the reviewed product may be broken out into factors such as price, quality and functionality. A final rating may be assigned as a composite of the individual factor scores. A global rating may be calculated based on the average of all submitted reviews for a given product.

Each video may be eligible for profit sharing from its profit generated by advertisement or other means. Eligible videos can gain single rewards and rewards can be accumulated and exchanged for cash value once the company/product is profitable. Various mechanisms can be developed for the redemption of rewards.

The website may be divided between commercial and non-commercial users. Commercial members can run a campaign based on their specific rewards to be given to eligible members in exchange of fees the service will be awarded to commercial users.

The web site can retain the right to remove any video that may be potentially harmful, contain inappropriate materials, or that include misleading comments, for example. Members can report videos as spam or inappropriate.

Doing so can send a flag for an administrator to further investigate and decide whether to delete the video. If a video receives multiple negative reports before an administrator can review, the video may be temporarily removed from view until the administrator has an opportunity to review the video.

Users can browse the videos and compare them within a category. Members can leave comments or agree or disagree with videos. Such comments, however, typically will not change a rating given by the initial reviewer. Each member can rate other members based on factors such as credibility, presentation and knowledge, for example.

The website can have periodic prize drawings, where a gift may be given to the winner(s). The entries can be based, for example, on each video post a member makes.

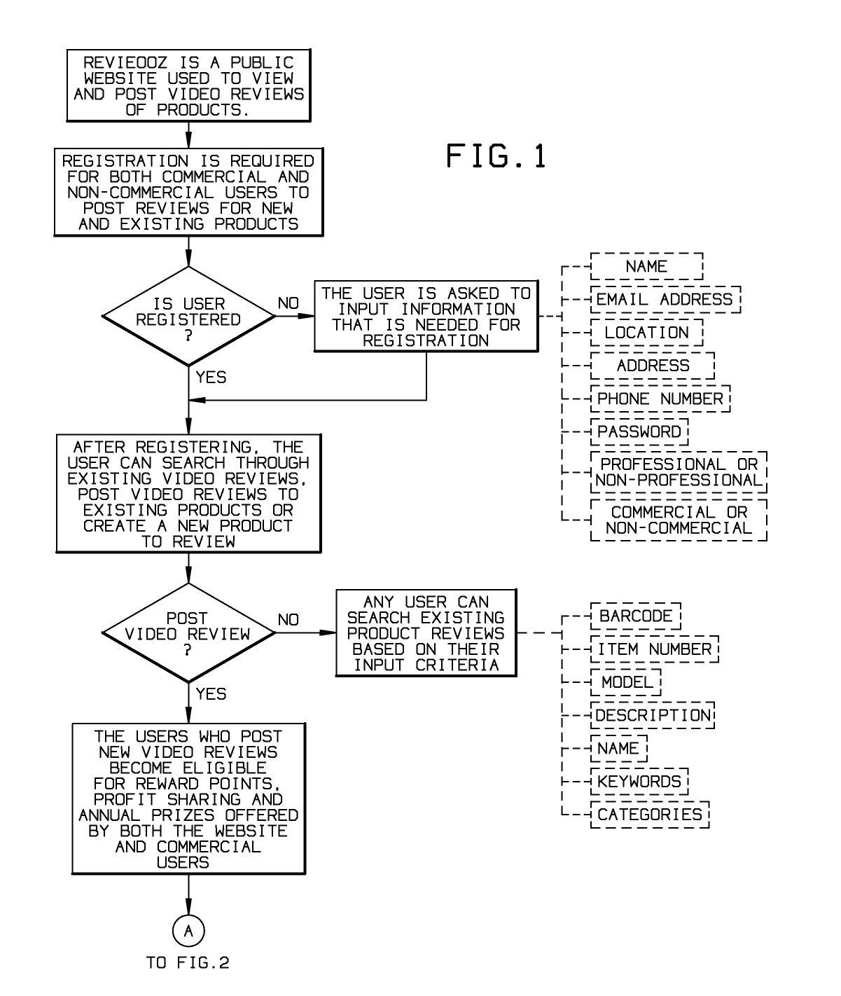

Referring to FIG. 1, a user may register for the video review website, herein described as “revieooz”. The registration may be divided into commercial and non-commercial users. Various information can be asked for registration, such as the user's name, email address, physical address, phone number, password, any affiliation or organization to which they belong, their status as a professional or non-professional, their status as commercial or non-commercial, and the like. Privacy settings may be used to limit the sharing of some or all of the provided information.

If the user, after registering (or entering their user name and password, if already registered), does not wish to post a review, they can search reviews by a variety of manners. If the user decided to post a review, they may be eligible for reward points, prizes, and the like.

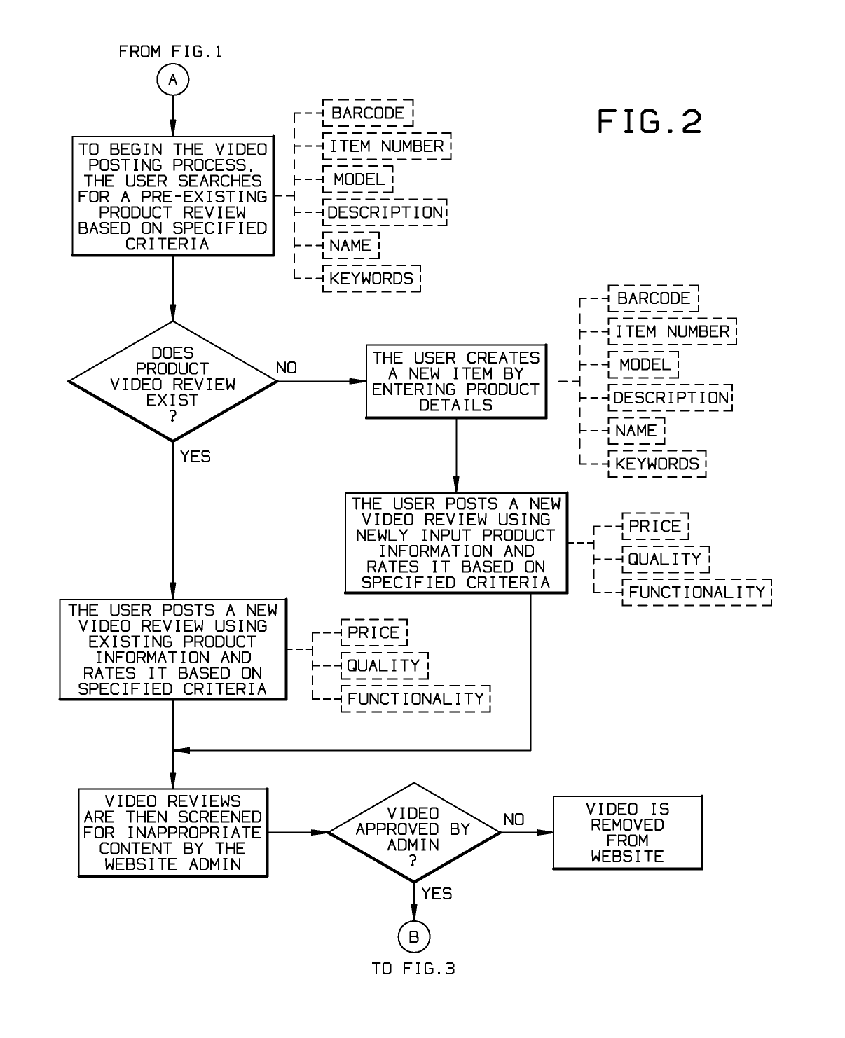

Referring to FIG. 2, where the user decides to post a video review, they may initially search to see if the product has been reviewed previously. If so, the user may post another review under that product. If the product has not yet been reviewed, the user may create a new item by entering the product details. In either case, the user may then post their video review, including ratings based on several independent factors, such as price, quality and functionality. If the posting is deemed inappropriate, it may not be posted (or may be posted and later removed) to the website. If the posting is appropriate, the video is approved.

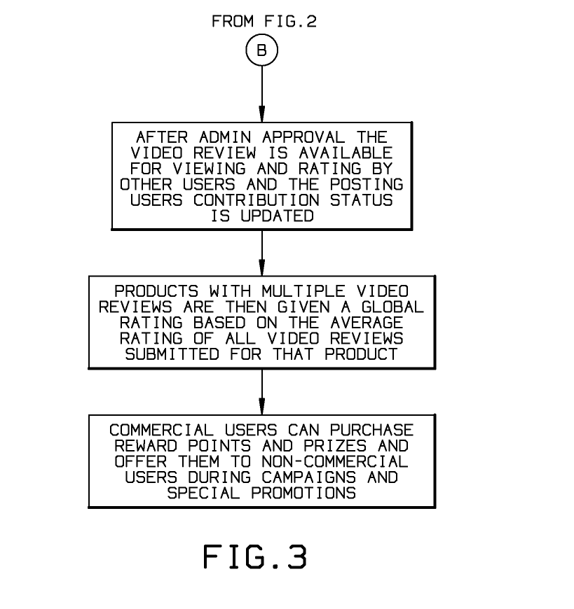

Referring to FIG. 3, once the video is approved, it is publically available for other users to review. The other users may rate the review and/or the reviewer. When products have multiple reviews, a global rating may be assigned, based on the average of the prior reviews. Commercial users may purchase reward points and prizes to offer reviewers during campaigns and special promotions.

It should be understood, of course, that the foregoing relates to exemplary embodiments of the invention and that modifications may be made without departing from the spirit and scope of the invention as set forth in the following claims.

What is claimed is:

1. A computer-implemented method, written as a programmable code, stored on a computer readable medium, and adapted to provide a product review website, the method comprising:
accepting a video review about a product from a user;
accepting a product rating for the product, the product rating including a plurality of product factors, each of the plurality of product factors receiving their own individual review score;
permitting users to search and see the product reviews; and
permitting users to comment on product reviews.

2. The method of claim 1, further comprising generating a product rating based on a compilation of the individual reviews scores on each of the plurality of product factors.

3. The method of claim 1, further comprising generating a global product rating based on a compilation of multiple reviews on the product.

4. The method of claim 1, further comprising requiring users to register prior to accessing the product review website.

5. The method of claim 1, further comprising permitting users to rate users.

6. The method of claim 5, wherein ratings of users are based on credibility, presentation and knowledge.

7. The method of claim 5, further comprising displaying the user's rating along with the user's video review.

8. The method of claim 1, wherein the factors include price, quality and functionality.

9. The method of claim 1, wherein the users are split into a commercial user group and a non-commercial user group.

10. The method of claim 1, further comprising providing a reward system to reward users for submitting video reviews.
